(19) United States
(12) Patent Application Publication
(10) Pub. No.: US 2010/0072732 A1
(43) Pub. Date: Mar. 25, 2010

(54) Vehicle frame assembly

(76) Inventor: David Leslie Offord, Maidenhead (GB)

Correspondence Address: WILLIAM D. HALL, 10850 STANMORE DR, POTOMAC, MD, 20854, US

(21) Appl. No.: 12/311,485

(22) PCT Filed: Oct. 5, 2007
(86) PCT No.: PCT/EP2007/060590

§ 371 Date: Dec. 7, 2009

(30) Foreign Application Priority Data
Oct. 6, 2006 (GB) 0619755.2

(51) Int. Cl. B62B 7/00

(52) U.S. Cl. 280/647

(57) ABSTRACT

A vehicle frame assembly (4) which includes an interface portion (10) having first and second mounting regions for releasably mounting on the assembly (4), one behind the other, respective first and second child-carrying units (12) in an echelon formation upwardly relative to the assembly (4) wherein the interface portion (10) is a sub-fame assembly detachably connected to the frame assembly (4).

This invention relates to an apparatus and method for the mounting of child-carrying units to a frame assembly.

According to a first aspect of the present invention, there is provided a vehicle frame assembly which includes an interface portion having first and second mounting regions for releasably mounting on said assembly, one behind the other, respective first and second child-carrying units in an echelon formation upwardly relative to said assembly, wherein said interface portion is a sub-fame assembly detachably connected to said frame assembly.

According to a second aspect of the present invention, there is provided a method of mounting first and second child-carrying units one behind the other, in an echelon formation upwardly, on a vehicle frame assembly, comprising mounting on a first mounting region of an interface portion of said assembly the first child-carrying unit and mounting on a second mounting region of said interface portion the second child-carrying unit at a higher level than the first unit, wherein said interface portion is a sub-frame assembly for detachably connecting to said frame assembly.

Owing to these two aspects of the present invention, it is possible to provide a frame assembly capable of supporting two children which is relatively stable when weight is applied to one or both child-carrying units.

The vehicle frame assembly is, advantageously, a frame assembly for a wheeled vehicle, such as a perambulator.

By use of a sub-fame assembly detachably connected to the frame assembly, a single frame assembly can be converted between single and dual occupancy configurations by the addition of the interface portion.

The first and second mounting regions of the interface portion are preferably arranged to be at different heights above the ground.

Advantageously, the first and second child-carrying units are positioned one in front of the other on the interface portion.

In order that the invention can be clearly and completely disclosed, reference will now be made, by way of example, to the accompanying drawings in which:

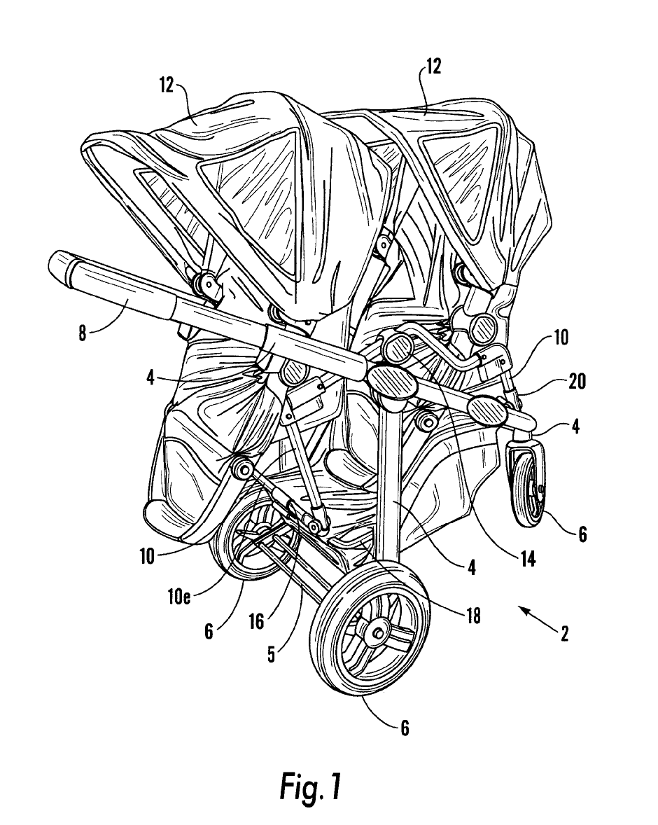

FIG. 1 is a perspective view from above of a vehicle with a frame assembly and an interface portion with two child seats in a rear-facing configuration,

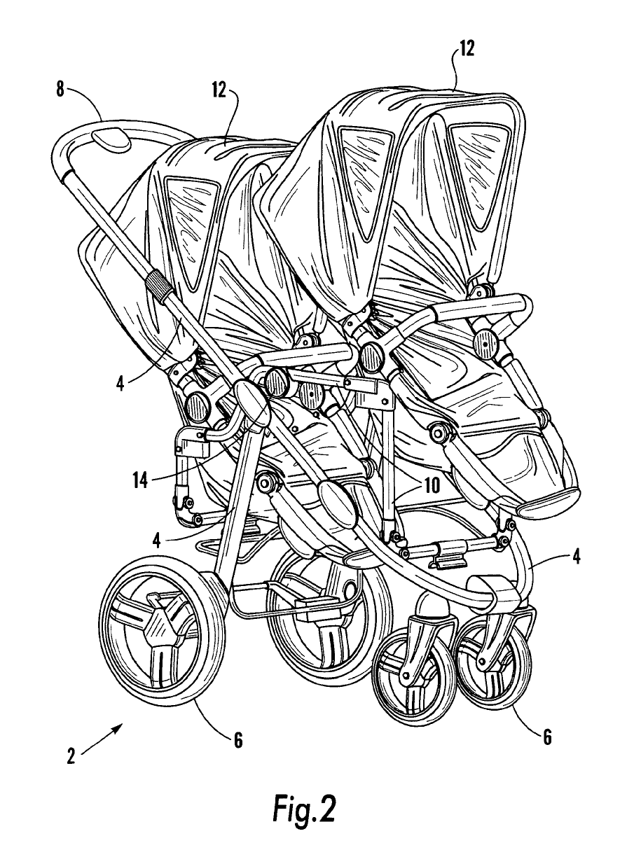

FIG. 2 is a perspective view of the vehicle with the child seats in a forward-facing configuration,

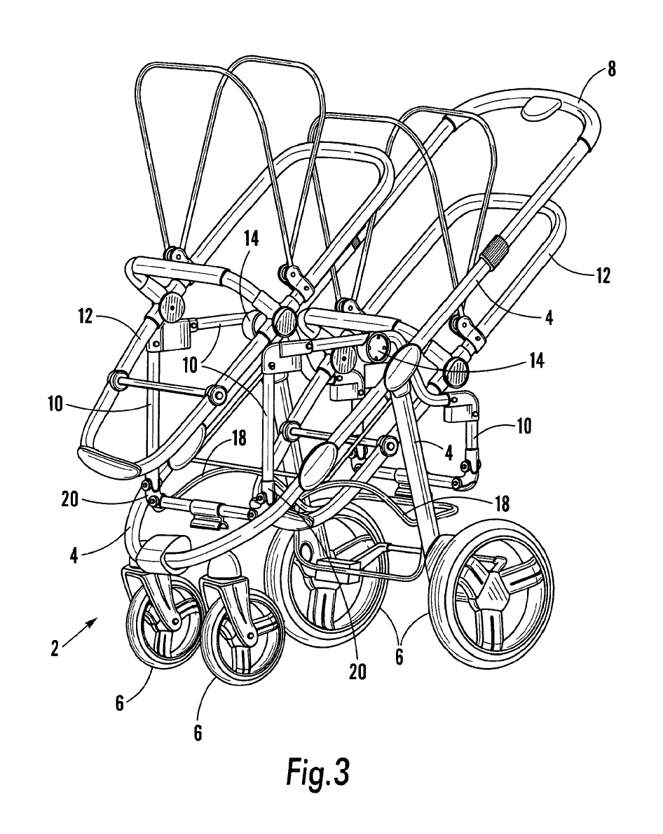

FIG. 3 is a perspective view of the vehicle with the seats in the forward-facing configuration, but with all the textile materials removed,

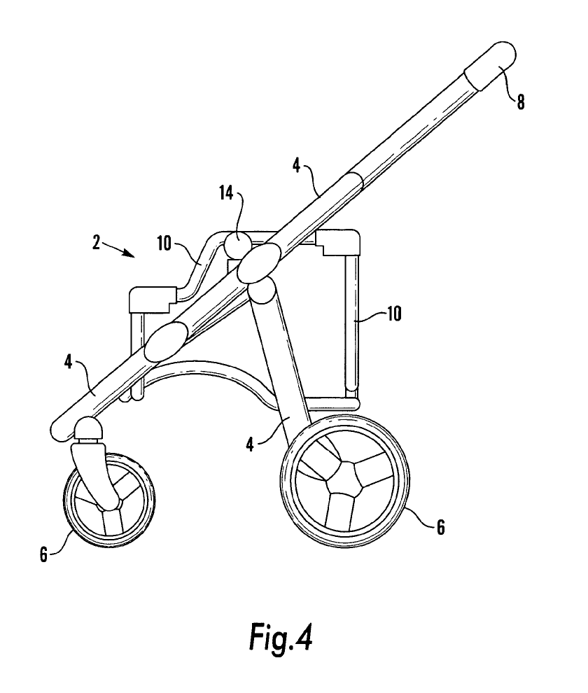

FIG. 4 is a side elevation of the frame assembly of the vehicle with the interface portion,

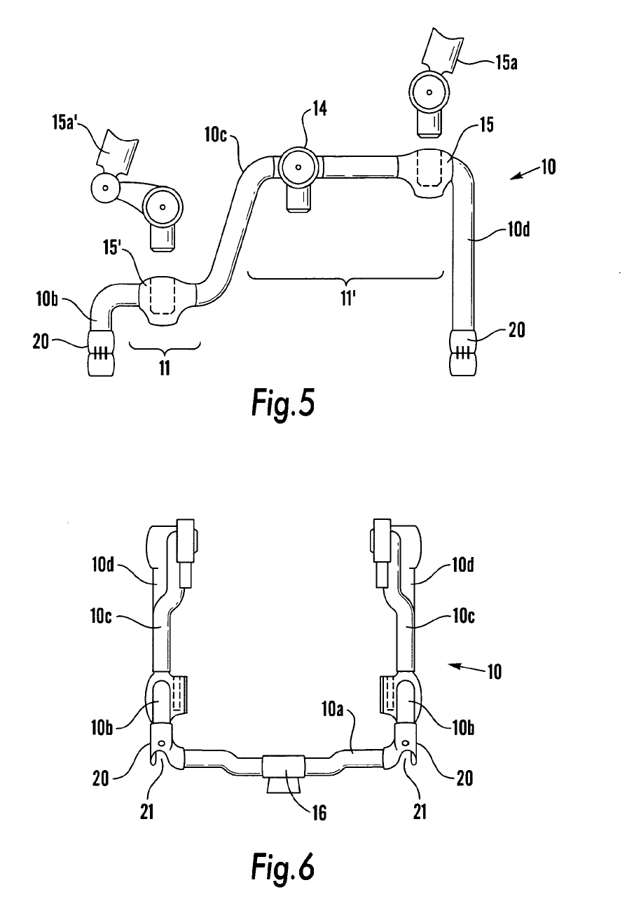

FIG. 5 is a side elevation of only the interface portion,

FIG. 6 is an end elevation of only the interface portion,

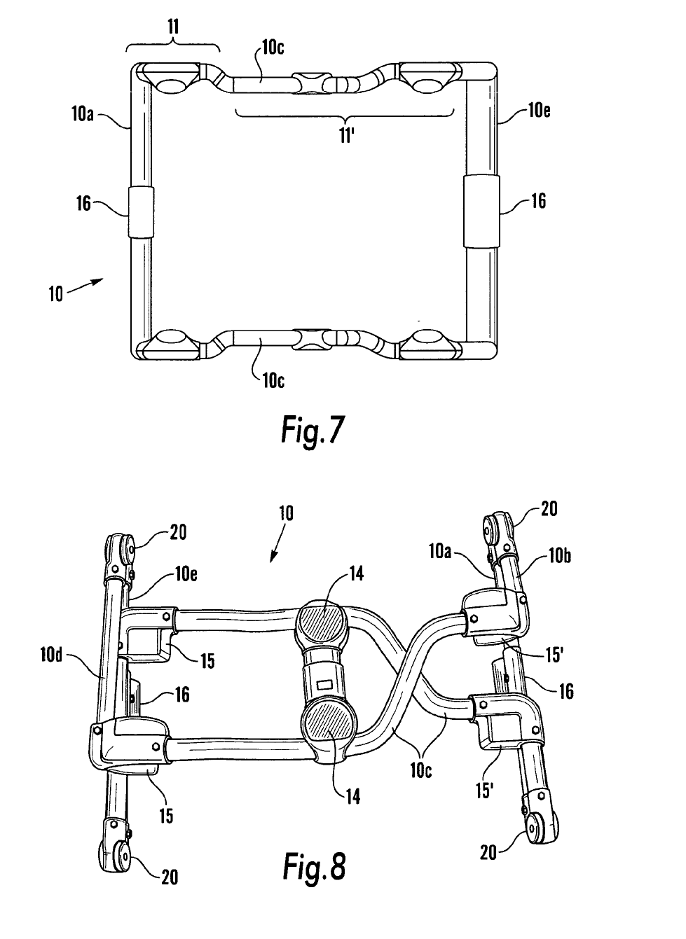

FIG. 7 is a plan view of only the interface portion, and

FIG. 8 is a perspective view of the interface portion in a folded condition.

Referring to FIGS. 1 to 4, a vehicle 2 for transporting children comprises a frame assembly 4, a plurality of ground-contacting wheels 6 attached to the frame assembly 4, and a handle 8 for grasping by the controller of the vehicle. The handle is a substantially inverted U-shaped member telescopically attached to the frame assembly 4 and a foot brake 5 is fitted to act upon the larger rear wheels 6. The vehicle 2 also includes an interface portion 10 which forms a sub-frame of the frame assembly 4 and which has mounted thereon, one behind the other, two child-carrying units in the form of seats 12 (with adjustable sun canopies).

The interface portion 10 is detachably connected to the frame assembly 4 by means of conventional self-locking insert-in-socket connectors 14 at central regions of respective lateral sides of the interface portion 10.

Referring to FIGS. 5 to 7, the interface portion 10 is substantially rectangular in plan view (see FIG. 7). It has an end crossbar member 10a connected to a pair of short substantially vertical struts 10b, each connected to a lateral bar 10c arranged substantially parallelly to each other, which are each connected to longer substantially vertical struts 10d extending downwardly and at their lower ends connecting to a second end crossbar member 10e, located at substantially the same level and being of substantially the same length as the end crossbar member 10a. Each lateral bar 10c includes a double-curved section towards the end where the shorter substantially vertical struts 10b are located, each double-curved section extending in respective substantially vertical planes arranged parallelly to each other. The double-curved section thereby forms two substantially horizontal sections 11 and 11′, the section 11′ being at a higher level in the substantially vertical plane than the section 11. Respective sections 11′ also include, proximal to the double-curve section, one part of the insert-in-socket connectors 14 for connecting the interface portion 10 to the frame assembly 4. Distal of the double-curve, the section 11′ also includes sockets 15 for receiving an insert of an adaptor piece 15a in a self-locking manner. Similarly, the lower section 11 includes sockets 15′ for receiving the insert of an adaptor 15a′.

The adaptors used can vary depending on the type of child-carrying unit to be attached to the interface portion 10. The vehicle 2 shown is capable of receiving, in addition to the seats 12 shown, infant car seats and carrycots, or a combination of such units.

The interface portion 10, in order to achieve suitable stability, is also supported at other locations on the vehicle 2, other than through the connectors 14 mentioned above.

Referring again to FIG. 1, the crossbar member 10e of the interface portion 10 has, at its central region, a clip 16 which clips onto a parallelly arranged rear crossbar of a basket frame 18, itself attached to the frame assembly 4. At the front end of the interface portion 10, corner pieces 20 between the shorter of the vertical struts 10b and the crossbar 10a are shaped so as to include a channel 21 (shown in FIG. 6) in order to closely receive and rest on top of forward portions of the basket frame 18.

Referring again to FIGS. 2 and 3, the interface portion 10 is dimensioned so as to be, when detached from the frame assembly 4, turned through 180° about its central vertical axis so that the seats 12 can, instead of being arranged in the rearward-facing configuration shown in FIG. 1, be arranged in a forward-facing configuration. In order to maintain stability of the interface portion 10 for this seating configuration, the crossbar member 10a also includes a clip 16 for attaching to the basket frame 18 and also has corner pieces 20 with channels 21 between the longer vertical struts 10d and the crossbar 10e to closely receive and rest on top of forward portions of the basket frame 18.

Whichever seating configuration is preferred, the seats 12 are arranged in a compact echelon formation, the seat 12 being mounted the interface portion 10 at section 11′ in the respective sockets 15 being slightly higher than the other seat 12 mounted on the section 11. There is also some degree of overlap between the rear part of the higher positioned seat 12 and the front part of the lower positioned seat 12, whilst still allowing a child to sit comfortably in the lower seat. The seats 12 are also capable, as is conventional, of reclining, typically thorough an angle of approximately 45° to a substantially horizontal position in order to accommodate very young children, such as babies. Even when the higher seat 12 is fully reclined, there is still sufficient room for a child to sit comfortably in the lower seat 12. This formation allows the vehicle to have good stability as any weight applied to either seat 12 is close to the centre of gravity of the vehicle 2 to prevent any dangerous tilting or toppling over of the vehicle.

Referring to FIG. 8, the interface portion 10 can be folded to an almost flat state for significantly reducing the volume of space occupied for storage and transportation purposes. By providing hinged corner pieces 20 each lateral side of the interface portion 10, comprised of one substantially vertical strut 10b, one lateral bar 10c and one substantially vertical strut 10d, is collapsible inwardly so that, in the folded state, the interface portion 10 lies in a single plane.

1-13. (canceled)

14. A vehicle frame assembly which includes an interface portion having first and second mounting regions for releasably mounting on said assembly, one behind the other, respective first and second child-carrying units in an echelon formation upwardly relative to said assembly wherein said interface portion is a sub-frame assembly detachably connected to said frame assembly and is supported by said frame assembly at lateral, forward and/or rearward regions of said sub-frame assembly.

15. A vehicle frame assembly according to claim 14, wherein said first and second mounting regions of said interface portion are arranged at different heights above the ground.

16. A vehicle frame assembly according to claim 14, wherein said sub-frame assembly is substantially rectangular in plan view.

17. A vehicle frame assembly according to claim 15, wherein said sub-frame assembly includes a pair of lateral bars arranged substantially parallelly to each other, each lateral bar having a double-curved section which lies in a substantially vertical plane.

18. A vehicle frame assembly according to claim 14, wherein said sub-frame assembly is rotatable, in the detached state, about its central vertical axis so that the child-carrying units can be arranged in a forward-facing or a rearward-facing configuration.

19. A vehicle frame assembly according to claim 15, wherein the rear part of the higher positioned child-carrying unit overlaps partially the front part of the lower positioned child-carrying unit.

20. A vehicle frame assembly according to claim 14, wherein said sub-frame assembly is foldable to lie in a single plane.

21. A vehicle frame assembly according to claim 14, wherein said sub-frame assembly comprises respective clips at the forward and/or rearward regions and connectors at respective lateral sides for supportingly attaching said sub-frame assembly to said frame assembly.

22. A vehicle frame assembly according to claim 21, wherein said forward and/or rearward regions further comprise respective corner pieces which include channels which are further supportingly received by said frame assembly.

23. A vehicle frame assembly according to claim 14, wherein said sub-frame assembly is supported at the forward and/or rearward regions by a basket frame of said frame assembly.

24. A method of mounting first and second child-carrying units one behind the other, in an echelon formation upwardly, on a vehicle frame assembly, comprising mounting on a first mounting region of an interface portion of said assembly the first child-carrying unit and mounting on a second mounting region of said interface portion the second child-carrying unit at a higher level than the first unit, wherein said interface portion is a sub-frame assembly for detachably connecting to said frame assembly and for supporting by said frame assembly at lateral, forward and/or rearward regions of said sub-frame assembly.

25. A method according to claim 24, wherein said supporting comprises connecting respective connectors at respective lateral sides of said sub-frame assembly and respective clips at said forward and/or rearward regions of said sub-frame assembly to said frame assembly.

26. A method according to claim 25, and further comprising receiving said frame assembly in channels formed in respective corner pieces of said forward and/or rearward regions.

27. A method according to any one of claim 24, and further comprising, in the detached state, rotating said sub-frame assembly about its central vertical axis for a forward-facing or a rearward-facing configuration of the child-carrying units.

28. A method according to claim 27, and in the detached state, folding said interface portion so as to lie in a single plane.
